(19) United States
(12) Patent Application Publication
(10) Pub. No.: US 2005/0033764 A1
(43) Pub. Date: Feb. 10, 2005

(54) Interactive editor for data driven systems

(75) Inventor: Ryan Reid, Studio City, CA (US)

Correspondence Address: BINGHAM, MCCUTCHEN LLP, THREE EMBARCADERO, SUITE 1800, SAN FRANCISCO, CA, 94111-4067, US

(73) Assignee: E.piphany, Inc., San Mateo, CA (US)

(21) Appl. No.: 10/913,589

(22) Filed: Aug. 5, 2004

Related U.S. Application Data
(60) Provisional application No. 60/493,017, filed on Aug. 5, 2003.

(51) Int. Cl. G06F 7/00

(52) U.S. Cl. 707/102

(57) ABSTRACT

A graphical active editor is provided that allows objects (code or configuration metadata) to be easily modified to adapt to changing business processes without requiring extensive knowledge of the underlying objects. A method of performing active editing includes executing an application program, displaying a user interface of the application program, displaying an object of the program in the user interface, and editing the displayed object while the application program is executing.

### CROSS-REFERENCE TO RELATED APPLICATIONS

This application claims benefit of U.S. Provisional Application No. 60/493,017 filed Aug. 5, 2003, which is incorporated by reference in its entirety.

### FIELD OF THE INVENTION

The present invention relates generally to computer systems and, in particular, to computer systems that support extension or customization.

### BACKGROUND OF THE INVENTION

A business can communicate with its customers over a network, for example, the Internet. A network connection can be used to connect a client computer to a server computer. The server can cause the client to display objects, such as a form, to a user. The user can use the form to send the requested information back to the server. With the proper objects, the business can use the server to acquire information from the users of the system.

A computer software program is used by the client and server to display the objects. However, if a business wishes to change the information that is displayed to a customer (e.g. customize or extend the system's functionality), the developer must locate and modify the code or configuration data (metadata) for the object. A complex application may have thousands of objects that could be edited. Finding the objects in a proprietary tool, such as code and/or metadata editor can be a difficult task as many objects are shared across forms and rarely do the underlying metadata objects have similar names or interfaces to the end user application. In particular, understanding which object is underlying the form to be edited by looking at the finished application is often impossible without prior understanding of the original metadata and/or code.

Prior art systems are typically based on customized programs tailored to a specific business process. As a result, these systems require an application developer to specify in advance how the data extracted from the underlying data sources is presented to the user. Furthermore, any changes to the way the data is presented or to the business process require modifications, often extensive, of the underlying programs to be performed by skilled programmers. As a result, systems as such implementing dynamic business processes that may need to be modified on a regular basis are expensive both in terms of time and of money. It would be desirable to provide a system that can be dynamically modified in response to changes in the underlying business processes.

### SUMMARY OF THE INVENTION

In accordance to the principles of the invention, a graphical active editor is provided that allows application objects to be easily added, deleted or modified to adapt to changing business processes. Active editing allows specific code (i.e. objects) to be found by clicking on a corresponding Graphical User Interface (GUI) representation, instead of searching through the source code and/or proprietary metadata. A method of performing active editing includes executing an application program, displaying a user interface of the application program, displaying an object of the program in the user interface, and editing the displayed object while the application program is executing.

### BRIEF DESCRIPTION OF THE DRAWINGS

FIG. 1 shows an example of an active editing system that executes enterprise software for a server to obtain information and data from a client.

FIG. 2 shows an example of an implementation of active editing has an active editing hook at each user interface element.

FIG. 3 shows an example of a method of active editing.

FIG. 4 shows an example of a graphical editor workspace.

FIG. 5 shows an example of a system to Recommend a Product to a Customer activity that is generated using the graphical editor.

FIG. 6 shows an example of a QuickView that is created with a graphical editor.

FIG. 7 shows an example of a multiple level system for active editing with the graphical editor.

### DETAILED DESCRIPTION

A method of active editing, according to some embodiments of the present invention, includes executing an application program, displaying a user interface of the application program, displaying an object of the program in the user interface, and editing the displayed object while the application program is executing. A graphical editor to perform active editing, according to some embodiments of the present invention, improves object discoverability, and increases the accuracy of development and configuration changes. With active editing, a developer can literally point to the object that he wants to edit, and therefore, the correct object is edited.

Overview

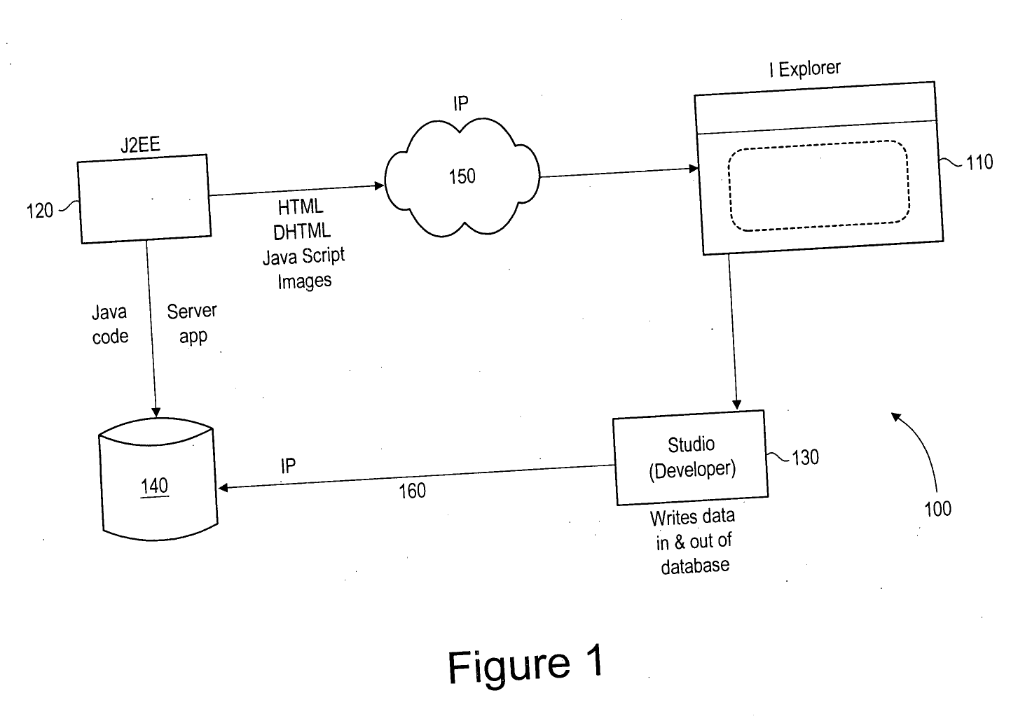

FIG. 1 is a block diagram of an example of active editing system 100. System 100 executes enterprise software for a server to obtain information and data from a client. The enterprise software logically includes three layers of functionality: an active editing end user application layer 110, an active editing runtime application layer 120, and an active editing configuration, coding, and development interface layer 130.

Active editing end user application layer 110 is displayed to the user so that the user can interact with the software program. End user application layer 110 may be executed by a computer processing system such as a client. Layer 110, when executed, may cause the client to display HyperText Markup Language (HTML) documents using an internet browser.

Active editing runtime application layer 120 performs the application by executing code stored in a database 140, such as metadata (declarative code) or data schema. Runtime application layer 120 may be executed by a computer processing system, such as a server, and may be connected to end user application layer 110 by a network 150, such as the Internet.

Active editing development interface 130 may be executed by a computer processing system, and may be used by a developer to create or customize the code stored in database 140 for end user application 110. Examples of development interface layer 130 include a coding interface, such as VisualCafe™ or VisualBasic™, or a proprietary configuration interface. Development interface 130 allows a developer to edit metadata in database 140, which may be in various formats. Development interface layer 130 may be a visual interface, such as a tree or a grid. Interface layer 130 may also be a “WYSIWYG” (What You See Is What You Get) interface, such as a form/HTML layout. The developer uses interface 130 to edit the application's metadata, compile code, and run the application to see the results.

Active editing functions may be performed with configuration layer 130. Active editing functions permit the developer to run and edit an application's metadata configuration tools simultaneously. The simultaneous run and edit may be performed by running the application in an active editing context of runtime layer 120, and including contextual tools displayed by the application within the end user's interface 110 which allow a developer to edit the underlying metadata objects in database 140.

When the application is executed by runtime application layer 120, a display in end user application layer 110 may contain a link 160 from end-user application display 110 back into metadata configuration tool 130. Thus, with active editing, a developer can run application code from database 140 with runtime layer 120, and edit corresponding metadata from the context of the display to the end user in layer 110, instead of editing configuration metadata in one tool, then executing the end-user application later to determine the results of the editing.

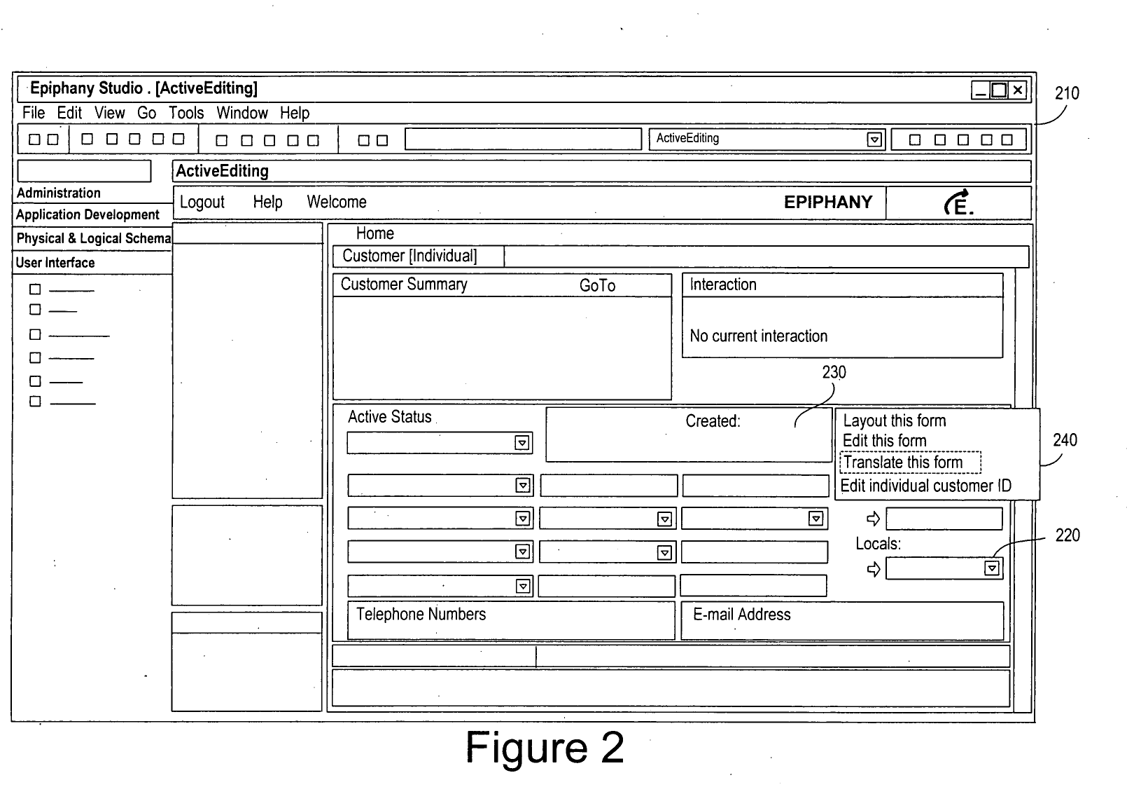

An implementation of active editing has an active editing hook at one or more user interface elements, as shown in FIG. 2. When an application is running, browser 210 is displayed by end user application layer 110. The browser 210 may display text box 220 on an HTML form 230. In active editing mode, an active editing decoration or wrapper, such as menu 240, is attached to the text box 220. Decoration 240 may include editing options to change, add, delete, or replace the underlying metadata object. For example, a developer may select “delete” from menu 240. Corresponding metadata for text box 220 is deleted from database 140. Runtime application layer 120 then executes the code, which is now without metadata for text box 220, and causes end user application layer 110 to display browser 210 without text box 220. The user interface file may be constructed and compiled with metadata information stored in database 140. The user interface file can then be processed by end user application layer 110.

In some embodiments, decoration 240 is implemented dynamically. For example, active editing decoration 240 may be dynamically shown or hidden based on the context of browser 210. If browser 210 is being hosted within an editing tool, then active editing decoration 240 is displayed. If browser 210 is hosted by an end user's desktop computer, then active editing decoration 240, including menus and options, remains hidden. Data for decoration 240 may be stored in a user interface file, such as a Java Server Page (JSP) file.

A messaging protocol, such as HyperText Transfer Protocol (HTTP), may be used in active editing. To identify which object to edit, decoration 240, which is constructed in the user interface file, has a unique name corresponding to an object as an argument to a custom JavaScript function. For example, decoration 240 may be a Dynamic HTML (DHTML) menu. When browser 210 is hosted in configuration tool 130, tool 130 adds, to an internet browser object model, a new scripting object that connects decoration 240 to tool 130. The new scripting object allows active editing code to manipulate tool 130 via HTML.

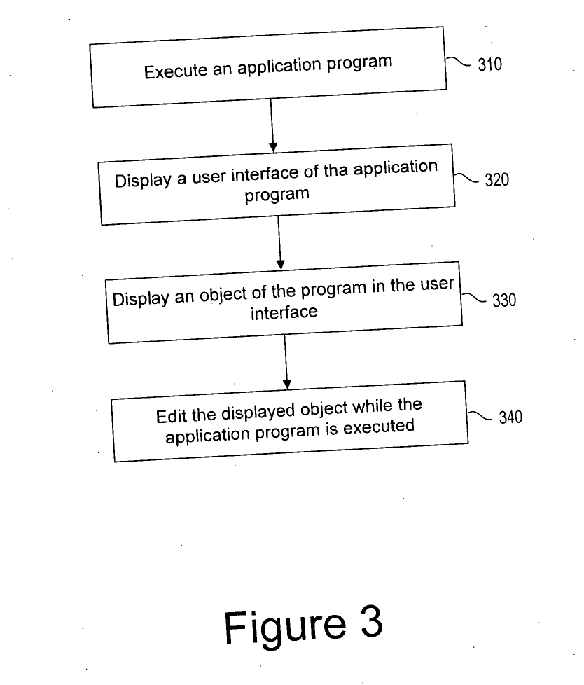

A method of active editing is shown in FIG. 3. An application program is executed, 310. A user interface of the application program is displayed, 320. An object of the program in the user interface is displayed, 330. The displayed object is edited while the application program is executing, 340. Displaying the user interface may include displaying a link to a configuration program for the application program in the user interface. The link may be used to execute the configuration program. Editing may be performed by displaying metadata for the displayed object in the user interface, and changing the metadata for the displayed object while the application program is executing. The changed metadata for the displayed object may then be executed. The displayed object may be an HTML document. The application program may be executed by a server, and the user interface may be displayed by a client. The client and the server may be connected by a network.

With active editing, the amount of required proprietary knowledge about an application, and the amount of time it takes to gain this knowledge, are both reduced. In an enterprise platform, a data bound object called a business information object (BIO) drives a great deal of what goes on in an application and has a large set of proprietary concepts associated with it. With active editing, the developer does not need to know all about BIOs, or even what a BIO means, because the developer runs the application. The developer can then edit the BIO using the active editing menu to link to the BIO. The required skill level of developers or custom configuration computer programmers may therefore be lower. Also, a user can know and understand the end user interface, and therefore can get to the underlying objects and their corresponding metadata and code easier.

The following examples show the benefits of using a graphical editor in accordance to some embodiments of the invention in a Customer Relationship Management (CRM) system. It will be appreciated that any graphical editor may be utilized and the invention is not limited to the editor described below.

CRM Related Examples of Systems with Graphical Editors

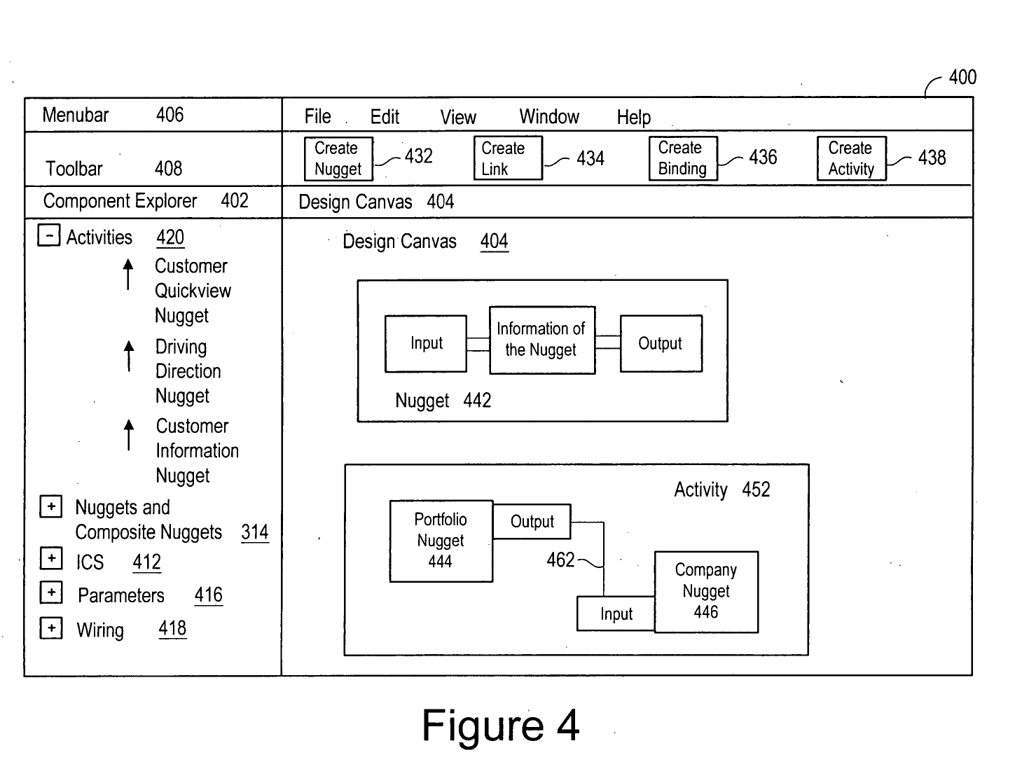

FIG. 4 shows an example of graphical editor workspace 400 that includes Component Explorer 402, Design Canvas 404, Menubar 406, and Toolbar 408. Component Explorer 400 displays types of components that can be used with graphical editor 400, including new components created by users and stored components retrieved from a database. A designer can edit components in Design Canvas area 404 using options provided by Menus 406 and Toolbar 408. Graphical editor 400 allows a user to configure business information, such as sales intelligence, by creating and editing components.

Components

The Components used by graphical editor 400 of a CRM system include Information Components (ICs) 412, Parameters 416, Activities 420, Nuggets and Composite Nuggets 414, and Wiring 418, as shown in FIG. 4.

Information Components (ICs) 412 represent encapsulated business logic and are used to connect and retrieve information from Source Systems. ICs are written in Java and have well-defined input and output Parameters. Examples include an IC that connects to a company's financial system to retrieve financial information about an individual, or an IC that makes a call across the Internet to retrieve real time data such as traffic or stock quote data. ICs typically gather data and present it to the end user.

Nuggets 414 represent configured instances of Information Components, and are used in Activities. Nuggets have input and output parameters. Composite Nuggets contain multiple Nuggets.

Wiring 418 is used to facilitate interaction among components of the graphical editor, and include Links and Bindings. Links are used to define Active Paths between Nuggets within an Activity. Bindings are used to define how data is passed around between subcomponents between Nuggets and Composite Nuggets within an Activity.

Activities 420 are collections of Nuggets and Links. In an Activity, Nuggets represent information, and Links connect Nuggets together. The Activity, therefore, provides a way for a user to logically or sequentially navigate from one Nugget to another across a connecting Link.

Parameters 416 are predefined data types that set the types of input and output data definitions of Nuggets and Activities.

Creating and Editing Components with the Graphical Editor

Graphical editor 400 allows a user to edit existing sub-components in Design Canvas area 404. A user may open an Activity, Nugget or Composite Nugget. The component type opens in Design Canvas 404. The user selects a sub-component and views its properties. A dialog box opens, to allow the user to edit properties of the sub-component. If the sub-component is a Nugget, the user may use Active Path editor 400 to edit the Local Name, which is a unique name of the Nugget, or make the Nugget the Start Nugget. If the subcomponent is an IC, a user may edit the Local Name field of the IC.

With graphical editor 400, the user can perform editing functions, such as: modify existing Activities and Composite Nuggets; build new Activities from existing Nuggets and Composite Nuggets; build new Composite Nuggets from existing Nuggets; build new Nuggets from existing Information Components; and get reports from external Source Systems With active editing, a user may create, edit, and wire components in the Design Canvas area.

The following processes are examples of creating and editing components, including nuggets, links and bindings, and activities, using active editing.

Creating and Editing Nuggets

Creating a Nugget may be performed by selecting Nuggets icon 432, which causes an empty Nugget 442 with input and output rectangles to appear in Design Canvas area 404. Available ICs 412 appear in Component Explorer 402. To add an IC to Nugget 442, a user may select an IC in Component Explorer 402 and drag it onto Canvas 404.

In Component Explorer 402, Parameters 416 may be expanded, to cause Parameters available for Nugget 442 to appear. The user determines an input parameter by selecting a parameter and dragging it onto the input rectangle of Nugget 442 in Design Canvas 404. An output parameter is also selected by dragging it to the output rectangle of Nugget 442 that is displayed in Design Canvas 404. Parameters 416 are predefined data types that set the types of input and output data definitions of Nuggets and Activities.

An example of a Nugget's input Parameter is a metadata-only pseudo-Java Parameter that represents the input properties that an IC input Parameter declaration expects from the outside (for example, from hyperlink parameters sent on a link). A pseudo-Java Parameter is used when names, properties, and types of Parameter 416 are registered in metadata. However, a Java class may not encapsulate a Nugget's input Parameter. For example, if an IC input has five properties, and three of these properties are declared as part of the IC input declaration, the Nugget input Parameter would consist of the two properties that were not declared.

An example of a Nugget's output Parameter is a pseudo-Java Parameter that represents the possible output Parameters that a Nugget makes available to the outside via different types of links. Each Nugget output Parameter is created as a result of a Parameter declaration. Metadata declarations that describe a Nugget's output Parameter specify post-processing that describes the wiring between what a user clicks on a link in the front-end and back-end data.

An existing Nugget's input and output parameters may be viewed by expanding Nuggets and Composite Nuggets 414 in Component Explorer 402, selecting a Nugget, and selecting input and output components. A Nugget opens in Design Canvas area 404, and the input and output properties of the Nugget appear.

Creating a Composite Nugget may be performed by selecting a Composite Nugget in Component Explorer 402. Input and output rectangles appear in Design Canvas 404. The user sets the input and output parameters, as discussed above. Then, in Component Explorer 402, the user expands Nuggets and Composite Nuggets icons to cause available Nuggets appear. The user may then select and drop Nuggets onto Design Canvas 404.

Creating and Editing Activities

An Activities is a collection of Nuggets and wires. A Nugget represents information pertaining to Activities. A wire connects Nuggets inside an Activity, and allows the user to navigate between Nuggets.

Activities may be created by graphical editor 400. In the Toolbar, a user selects an Activities icon 438, and one or more empty Activity windows, such as 452, appear in Design Canvas area 404. Nuggets and Composite Nuggets are created and/or placed into activity window 452 of Canvas 404.

If a window has multiple nuggets, such as 444 and 446, a wire 462, including a link portion and a binding portion, can be created between Nuggets. The user may draw an intra-Activity link portion for wire 462 between Nuggets 444, 446 by selecting an output connector of one Nugget, and an input Connector of another Nugget, to establish the Link. Properties for the Link portion of wire 462 may then be edited. For example, desired Parameters are selected from Component Explorer 402 and placed into a target Nugget's input block and a source Nugget's output block of activity window 452 in Canvas 404.

Also, a Binding can be created for wire 462 by associating the input connector of target Nugget 446 with the output connector of source Nugget 444, to bind the type of data that is input to target Nugget 446 with the output Parameter of source Nugget 444. If the Properties window displays multiple Parameters, the user can bind the output connector to one or more Parameters.

Creating and Editing Wires within an Activity

A wire can include a link portion and a binding portion. A link defines an Active Path between Nuggets within an Activity. A binding defines how data is passed around between subcomponents within an Activity, Nugget, and Composite Nugget.

For example, Activity 452 includes two Nuggets, a stock portfolio display Nugget 444 and a company detail display Nugget 446, as shown in Design Canvas 404. Stock portfolio Nugget 444 is the starting point of Activity 452, and for each stock listed in the portfolio, a user wants to navigate to the detailed company screen for that stock.

To realize this configuration, wire 462 is created from portfolio Nugget 444 to company Nugget 446, including a link and a binding. To create a link portion of wire 462, the user selects an icon for link creation 434, displayed in Toolbar 408. Then, the output connector of portfolio Nugget 444 and the input connector of company detail Nugget 446 are both identified, to establish the beginning and end of the link between the two nuggets. Runtime system 120 automatically generates this navigation path from the portfolio to the company detail.

A Binding may also be created for wire 462, to define the Parameter, or type of data, that travels across the link, from one Nugget to another. The user may identify parameters that are available for wiring by selecting the input and output connectors of link 462. The selected connectors expand to show the available properties for wiring. To create a binding portion of wire 462, a new binding process is initiated by selecting create binding icon 436. The user selects the output connector of target Nugget 444 and the input Parameter connector of source Nugget 446. If the Properties window displays multiple Parameters, a user may select one or more for binding. The selected Parameters are bound to the link.

Returning to the example of wiring a portfolio Nugget and a company Nugget, the Binding may be used to select the type of information that is input to company Nugget 446 by portfolio Nugget 444. In this case, the desired type of parameter from portfolio Nugget's output is TickerSymbol information. Parameters of portfolio Nugget 444 are displayed, and show that the output of portfolio Nugget 444 is TickerSymbol data. The user desires this information to be received by company detail Nugget 446.

To do this, the user binds the output data from portfolio Nugget 444 to the input of company Nugget 446. The user selects a company to be associated with company detail display Nugget. A process to create a new binding is started, to create a binding between the portfolio output and the company input. The user selects the TickerSymbol parameter for the output connection of portfolio Nugget 444, and for the input connection to company Nugget 446. Thus, the user can specify that the output of portfolio display Nugget, which is a TickerSymbol, is to be passed to the input of company detail Nugget. Then, when the user navigates link 462 between the two Nuggets, the desired TickerSymbol information is passed to target Nugget 446.

In general, a user may determine whether a property or type of data for a Nugget can be connected to another Nugget by checking the Nugget's properties. If the user selects connectors that represent the input and output connectors of a Link, the selected connectors expand to show which properties are available for wiring. Links and bindings may be edited by viewing and changing their properties.

Systems Generated with Graphical Editors

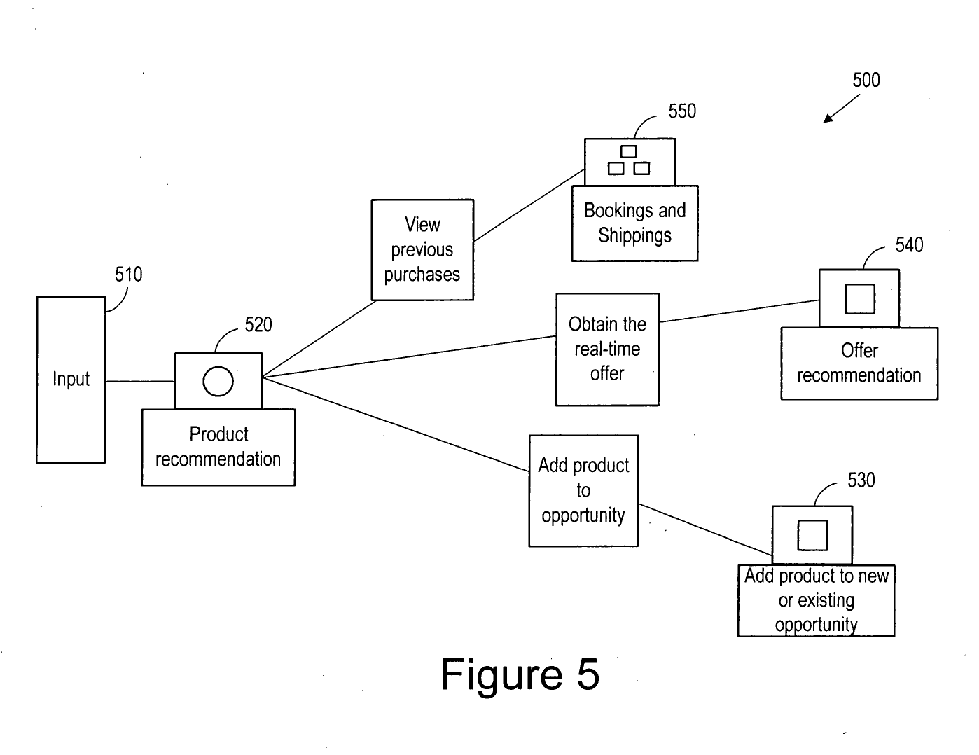

FIG. 5 shows an example of a system to Recommend a Product to a Customer activity that is generated using a graphical editor. Activity 500 provides the salesperson with the optimal product recommendations for a particular customer, maximizing the chances of completing a sale. Activity 500 takes input 510 of a semantic type Customer.

Product Recommendation nugget 520 is the Start nugget for this activity. Nugget 520 receives semantic type Customer information from input 510. For example, Nugget 520 may retrieve targeted Product Recommendations from a Real Time Personalization Engine for the customer. To accomplish this, the customer property of activity input 510 is linked to a customer property input of Product Recommendation nugget 520 using graphical editor 500 to generate wire 522.

Links 532, 542, 552 are drawn from Start nugget 520 to Next Steps 530, 540, 550 in activity 500. Add Product to New or Existing Opportunity nugget 530 is used to add the product recommendation returned by Product Recommendation nugget 520 to a new or existing opportunity in the editor computer program. The end user has the option of selecting the product to add to an opportunity in the front end.

Nugget 530 takes inputs of semantic types of a Customer and Product. The Customer input may be wired from another activity input and the Product input is wired from the output of Product Recommendation nugget 520. To accomplish this, link 532 is drawn from Product Recommendation nugget 520 to Add Product to New or Existing Opportunity nugget 530 using graphical editor 500.

A link 542 is established from Product Recommendation nugget 520 to Offer Recommendation nugget 540. Offer Recommendation nugget 540 returns Offer Recommendations from the Real Time Personalization Engine for the Customer. Nugget 540 receives an input of a semantic type Customer. An activity input is wired to the input of nugget 540 using graphical editor 500 by drawing link 542 from Product Recommendation nugget 520 to Offer Recommendation nugget 540.

Bookings and Shippings for an Organization nugget 550 is a Composite nugget. Nugget 550 contains individual nuggets, such as a Product Booked for an Organization and a Product Shipped to an Organization nugget. Individual nuggets can output report from an analytic service. Link 552 is used to wire Nugget 520 to Composite Nugget 550.

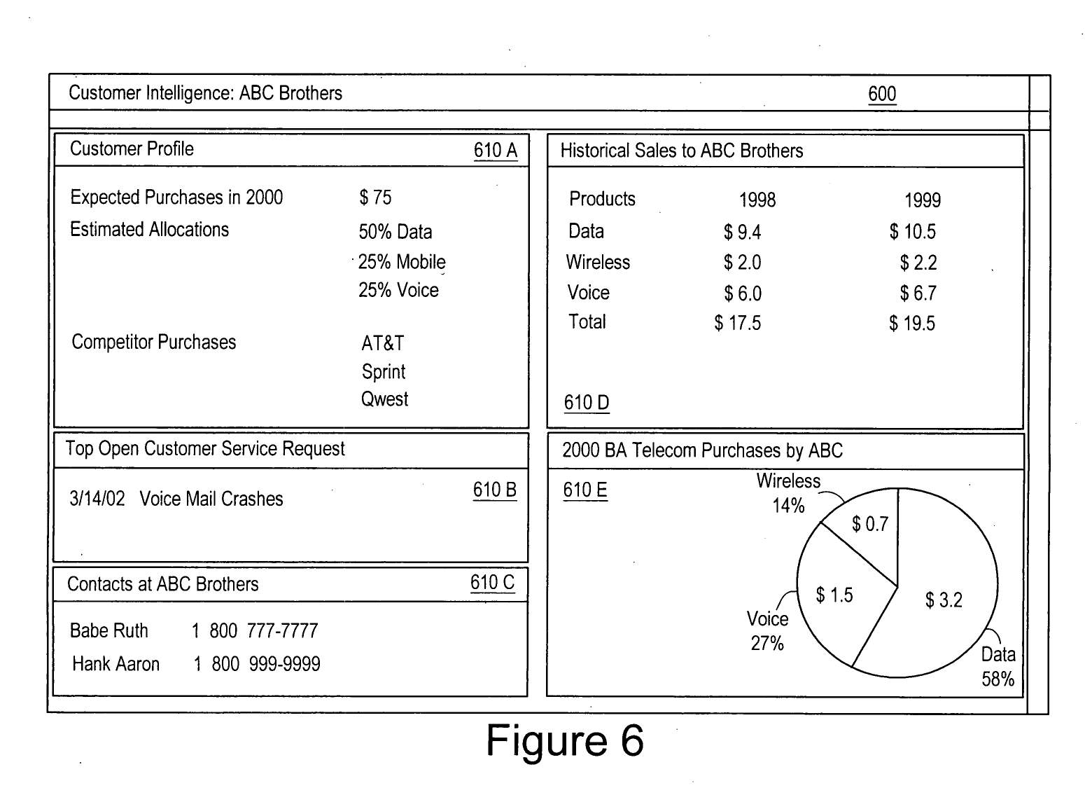

FIG. 6 shows an example of a snapshot of activity page 600, or QuickView, that is created with a graphical editor. QuickView is used to aggregate relevant account information from multiple sources, and to provide a single view of the customer. QuickView 600 is a collection of several nuggets from any number of information sources which are displayed on a single page.

Customer Intelligence QuickView 600 displays Customer Profile Nugget 610A, Customer Service Request Nugget 610B, Customer Contacts Nugget 610C, Historical Sales to Customer Nugget 610D, and Customer Telecom Purchases Nugget 610E. QuickView 600 allows users to quickly prepare for customer meetings and become informed about the current status of an account. A salesperson could access Customer QuickView 600 prior to a meeting that afternoon with the client. QuickView 600 provides up-to-date information Nuggets about the customer, which the sales person can use to identify most recent purchases and purchasing patterns and open service requests, and determine an appropriate sales approach to pursue.

Building QuickView with a graphical editor, such as editor 400, may include assembling nuggets related to a particular topic (for example, Sales Effectiveness or What's Hot Nuggets) and adding the resulting composite nugget to an activity. End users can customize QuickView 600 by configuring the layout of nuggets that comprise QuickView 600. In some embodiments, both display options and page contents of a QuickView can be customized.

In some embodiments, display options pertain to nuggets contained in QuickView 600 and involve specifying end-user settings such as the maximum number of rows to show in a table, or the output type for a report (such as chart, table, or both). Page Contents specify how nuggets are positioned on QuickView. This may include determining whether a nugget should be in a single column or two columns, which nugget should be added or dropped from QuickView, and which nuggets should go on the right or left side of QuickView 600.

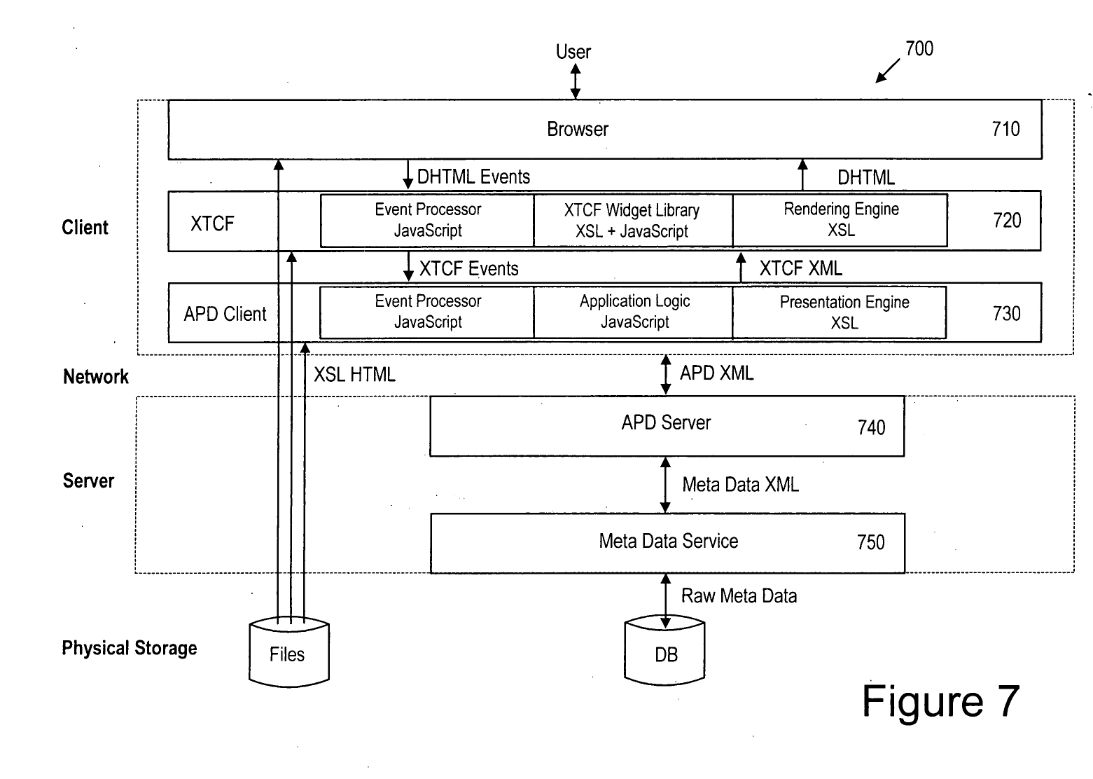

FIG. 7 shows an example of a multiple level system for active editing with a graphical editor 700. Graphical editor 700 is displayed to a user by a browser of client computer 710. Components of a CRM system, such as activities, are displayed in Component Explorer of client browser 710. The user selects an activity for editing. Client browser 710 sends DHTML event 712 that represents the selected activity to XTCF application processor 720. Processor 720 uses event processor 722 and XTCF component library 724 to convert DHTML event 712 for the activity into XTCF event 726, and sends XTCF event 726 to APD client 730. APD client 730 generates XML request for data and metadata of the activity 732 and sends request 732 to APD server 740.

APD server 740 retrieves the requested data and metadata of the activity from meta database 750, and returns the requested information 742 to APD client 730. Presentation engine 734 of APD client 730 uses an Extensible Style Language (XSL) to re-format the information as XTCF data stream 736, so that rendering engine 728 of XTCF processor 720 can read the information. Rendering engine 728 of XTCF processor 720 uses component library 724 to determine how the data and metadata of the selected activity should be converted into message 714 in a DHTML format, so that client browser 710 can properly display this information to the user. Rendering engine 728 sends activity information 714 to browser 710 in the DHTML format, to cause browser 710 to open an XTCF window on a Design Canvas of a graphical editor, and to display DHTML-formatted information 714 for the activity in an XTCF window.

The user can then edit the activity using graphical editor 700. The changes to the activity are then sent from the browser of client computer 710 to meta database 750 through XTCF 720, APD client 730, and APD server 740. Definitions of other components, such as bindings for an input to a sub-component, can also be created and edited using system 700.

These and other embodiments of the present invention may be realized in accordance with the above teachings and it should be evident that various modifications and changes may be made to the above described embodiments without departing from the broader spirit and scope of the invention. The specification and drawings are, accordingly, to be regarded in an illustrative rather than restrictive sense and the invention measured only in terms of the claims.

1. A method comprising:
executing an application program;
displaying a graphical user interface of the application program, including at least one displayed object; and
editing the displayed object while the application program is executing.

2. The method of claim 1 wherein displaying the graphical user interface further comprises:
displaying a link to a configuration program for the application program in the graphical user interface.

3. The method of claim 2 further comprising:
using the link to execute the configuration program.

4. The method of claim 1 wherein editing further comprises:
displaying metadata for the displayed object in the user interface.

5. The method of claim 4 further comprising:
changing the metadata for the displayed object while the application program is executing.

6. The method of claim 5 further comprising:
executing the changed metadata for the displayed object.

7. The method of claim 1, wherein the displayed object is a HTML document.

8. The method of claim 1, wherein the application program is executed by a server.

9. The method of claim 8, wherein the user interface is displayed by a client.

10. The method of claim 9, wherein the client and the server are connected by a network.

11. A method of executing and editing an application program, comprising:
executing the application program;
displaying a graphical user interface of the application program, including one or more displayed objects;
receiving input from a user through the graphical user interface to identify at least one of the displayed object;
displaying metadata for the identified object in the graphical user interface;
receiving an editing input from the user to modify the displayed metadata for the identified object while the application program is executing; and
editing the displayed metadata based on the received editing input.

12. The method of claim 11 wherein displaying the graphical user interface further comprises:
displaying a link to an editor for the application program in the graphical user interface.

13. The method of claim 12 further comprising:
receiving a click of the link from the user; and
displaying the editor to the user.

14. The method of claim 13 wherein displaying the editor comprises:
displaying an editing decoration in the graphical user interface, the editing decoration including a plurality of editing functions.

15. The method of claim 14 wherein receiving input from the user to modify the displayed metadata comprises:
receiving an input from a user to identify at least one of the editing functions of the editing decoration.

16. The method of claim 11 further comprising:
modifying the executing application program based on the edited metadata.

17. The method of claim 11, wherein the displayed object is a HTML document.

18. The method of claim 11, wherein the application program is executed by a server.

19. The method of claim 18, wherein the graphical user interface is displayed by a client.

20. The method of claim 19, wherein the client and the server are connected by a network.

21. An apparatus comprising:
means for executing an application program;
means for displaying a graphical user interface of the application program, including at least one displayed object; and
means for editing the displayed object while the application program is executing.

22. The apparatus of claim 21 wherein said means for displaying the graphical user interface further comprises:
means for displaying a link to a configuration program for the application program in the graphical user interface.

23. The apparatus of claim 22 further comprising:
means for using the link to execute the configuration program.

24. The apparatus of claim 21 wherein said means for editing further comprises:
means for displaying metadata for the displayed object in the user interface.

25. The apparatus of claim 24 further comprising:
means for changing the metadata for the displayed object while the application program is executing.

26. The apparatus of claim 25 further comprising:
means for executing the changed metadata for the displayed object.

27. An apparatus for executing and editing an application program, comprising:
means for executing the application program;
means for displaying a graphical user interface of the application program, including one or more displayed objects;
means for receiving input from a user through the graphical user interface to identify at least one of the displayed object;
means for displaying metadata for the identified object in the graphical user interface;
means for receiving an editing input from the user to modify the displayed metadata for the identified object while the application program is executing; and
means for editing the displayed metadata based on the received editing input.

28. The apparatus of claim 27 wherein said means for displaying the graphical user interface further comprises:
means for displaying a link to an editor for the application program in the graphical user interface.

29. The apparatus of claim 28 further comprising:
means for receiving a click of the link from the user; and
means for displaying the editor to the user.

30. The apparatus of claim 29 wherein said means for displaying the editor comprises:
means for displaying an editing decoration in the graphical user interface, the editing decoration including a plurality of editing functions.

31. A computer readable article of manufacture storing a computer program, the computer program comprising:
code for executing an application program;
code for displaying a graphical user interface of the application program, including at least one displayed object; and
code for editing the displayed object while the application program is executing.

32. The program of claim 31 wherein said code for displaying the graphical user interface further comprises:
code for displaying a link to a configuration program for the application program in the graphical user interface.

33. The program of claim 32 further comprising:
code for using the link to execute the configuration program.

34. The program of claim 31 wherein said code for editing further comprises:
code for displaying metadata for the displayed object in the user interface.

35. The program of claim 34 further comprising:
code for changing the metadata for the displayed object while the application program is executing.

36. The program of claim 35 further comprising:
code for executing the changed metadata for the displayed object.

37. A computer readable article of manufacture storing a computer program, the computer program comprising:
code for executing an application program;
code for displaying a graphical user interface of the application program, including one or more displayed objects;
code for receiving input from a user through the graphical user interface to identify at least one of the displayed object;
code for displaying metadata for the identified object in the graphical user interface;
code for receiving an editing input from the user to modify the displayed metadata for the identified object while the application program is executing; and
code for editing the displayed metadata based on the received editing input.

38. The program of claim 37 wherein said code for displaying the graphical user interface further comprises:
code for displaying a link to an editor for the application program in the graphical user interface.

39. The program of claim 38 further comprising:
code for receiving a click of the link from the user; and
code for displaying the editor to the user.

40. The program of claim 39 wherein said code for displaying the editor comprises:
code for displaying an editing decoration in the graphical user interface, the editing decoration including a plurality of editing functions.

41. The program of claim 40 wherein said code for receiving input from the user to modify the displayed metadata comprises:
code for receiving an input from a user to identify at least one of the editing functions of the editing decoration.

42. The program of claim 37 further comprising:
code for modifying the executing application program based on the edited metadata.
